(19) United States
(12) Patent Application Publication
(10) Pub. No.: US 2018/0249558 A1
(43) Pub. Date: Aug. 30, 2018

(54) ATTACHABLE ILLUMINATION SYSTEM

(71) Applicants: Bryn GRIFFITHS, Hong Kong, Hong Kong (CN); BENMORE VENTURES LIMITED, Tortola (VG)

(72) Inventors: Bryn Griffiths, Hong Kong (CN); Jon Duncan, Whitton, Middlesex (GB)

(21) Appl. No.: 15/553,434

(22) PCT Filed: Feb. 26, 2016
(86) PCT No.: PCT/GB2016/050505

§ 371 Date: Aug. 24, 2017

(30) Foreign Application Priority Data
Feb. 26, 2015 (GB) 1503250.1

(51) Int. Cl. H05B 37/02; F21V 31/00; F21V 23/04; H05B 33/08; A47G 19/22

(52) U.S. Cl. CPC H05B 37/0272; F21V 31/005; F21V 23/04; F21Y 2115/10; H05B 33/0845; A47G 19/2227; F21V 23/0492

(57) ABSTRACT

In a set of light-emitting devices, each capable of being attached to a respective container and each comprising lights, associated circuitry and a housing therefor having a surface capable of attachment to the container, a first device (12) comprises a transmission circuit (22) and a tilt switch (20) for actuating the transmission circuit to generate a respective transmitted signal, and second devices (14) each comprise a receiver circuit (32) capable of receiving the transmitted signal and illuminating the lights (36) of the device. The lights (26) of first device (12) are also arranged to illuminate simultaneously with the generation of the transmitted signal, and the device further comprises an on-off push switch (28). The devices may be part of an illumination system (50) comprising a transmitter unit (60) which also generates signals to illuminate lights (36). The signals transmitted by the unit (60) are encoded differently from those transmitted by first device (12) so as to produce different illumination effects. A further system (80) comprises a bottle-supporting unit (90) incorporating illuminated bottle placement areas (94).

The present invention relates to illumination systems and in particular to illumination systems comprising a set of light-emitting devices which operate in a wireless manner.

In a preferred embodiment, an illumination system comprises light devices suitable for illuminating the contents of containers, in particular transparent drinks containers. Devices of this type are disclosed in patent applications WO 2004/110892, WO 2011/007113, WO 2011/070336, WO 2011/070337 and WO 2011/070338.

Our earlier international patent application WO2012/160930 discloses the incorporation of a radio frequency transmitter in a motion-activated illumination device, but the receivers are incorporated in relatively-large tile members which are configured to be fixedly-located on shelves.

GB 2515845 A discloses an array of pixel units in the form of display devices. Although the devices include receivers and transmitters, the information they exchange is only positional information or information originating elsewhere, in particular from a central control unit. The individual devices do not include means for actuating the transmission of display information.

GB 2440784 A discloses an array of glow sticks for audience members in an entertainment venue, each glow stick incorporating a transceiver. The transceivers receive command signals from a central control and can communicate with each other.

In US 2014/0071681 A1 a common flash pattern is generated by lights on a master unit and those on slave units. The slave units may also serve to retransmit signals.

US 2007/0272879 discloses drinks glasses each incorporating a light source, a transceiver and a device which can be programmed to control the illumination of the light source. The devices can be programmed by means of a tray before the glasses are issued and via beacons during use.

Aspects of the present invention seek to provide an illumination system capable of providing one or more display effects.

Aspects of the present invention seek to provide an illumination system in which an event associated with one light device, e.g. the pouring or drinking of a drink from a container, can create an effect in other light devices attached to other containers.

According to a first aspect of the present invention there is provided a set of light-emitting devices, each capable of being attached to a respective container and each comprising a light, associated circuitry and a housing therefor having a surface capable of attachment to the container, wherein at least a first of the set comprises a transmission circuit and a user-actuated switch for actuating the transmission circuit to generate a respective transmitted signal, and at least a second of the set comprises a receiver circuit capable of receiving the transmitted signal and means, in response thereto, for illuminating the light of said second device.

An advantage of the devices is that they can be attached to conventional containers without the need to modify the container in any way. The containers are preferably containers for drinks, in particular transparent containers such as glasses and bottles, with the light being capable of illuminating the contents of the respective containers.

In preferred embodiments the first and second devices are structurally identical (only their circuitry may differ). This leads to rationalisation in the manufacturing process.

The first and second devices are preferably of the type disclosed in WO 2011/007113. Thus each light-emitting device may comprise a pad of liquid-impervious material and with electrical elements of the device attached to a central region of a major surface thereof, the central region being surrounded by an adhesive region of the major surface whereby the pad can be adhered to a container in liquid-tight manner to illuminate the contents thereof.

More specifically, each light-emitting device may comprise a pad with electrical elements of the light-emitting device attached thereto, the pad being of liquid-impervious material, the electrical elements being provided on a rigid circuit board which is attached to a central region of a major surface of the pad, and the central region being surrounded by an adhesive region of the major surface whereby the pad can be adhered to the container in a liquid-tight manner to illuminate the contents thereof and the pad is flexible and has a material composition which allows the pad to fold over the edges of the rigid circuit board without cracking or creasing.

The pad may be attached to the container in a relatively-inconspicuous manner. For example it can be attached to the bottom of a container without upsetting the stability of the container against rocking. The liquid-tightness of the pad allows the container to be exposed to liquids without the danger of the operation of the device being adversely affected.

Preferred pads are made from PVC or plasticised paper.

The pad is preferably in the form of a sticker.

The pads or stickers have the advantage of being small, flat, flexible and light portable articles.

The pads preferably have a thickness in the range 0.12 to 0.30 mm, more preferably 0.15 mm to 0.20 mm. The pads are preferably circular with a diameter of 25 to 70 mm, more preferably 27 to 60 mm. The pads may have a square or other non-circular shape, in which case their maximum dimension is 30 to 70 mm, more preferably 50 to 62.5 mm.

The pad may comprise a first layer to which the electrical elements are attached and a ring-shaped second layer covering and releasably attached to the adhesive region. A line of separation may extend across the second layer from the inner periphery of the ring to the outer periphery of the ring.

The first layer may comprise biodegradable plastics and/or paper material. In preferred arrangements the material of the first layer is stronger than the material of the second layer.

The pad may incorporate a ring of ethylene-vinyl acetate (EVA) which increases the thickness of the pad. Thus an EVA pad has a thickness in the range 1 to 5 mm, more preferably 2 to 3 mm. Typical diameters are 50 to 75 mmm more preferably 61 to 70 mm. An EVA pad is advantageous where the base of the container to which it is attached has no recess or only a shallow recess, the EVA pad acting as a cushion for the container to sit on and allowing more space for the circuitry.

The electrical elements may be provided on a rigid printed circuit board.

The switch of the or each first device is preferably a motion-sensitive switch such as a tilt switch. This enables automatic actuation of the transmission circuit, e.g. when picking up and/or pouring from a drinks bottle to which the first device is attached, so that no separate action is necessary by the user. The switch may be constituted by a vibration sensor.

The or each first device may comprise means for illuminating the light of said first device simultaneously with the generation of the transmitted signal. This enables an effective display in which a plurality of lights distributed around a venue can be simultaneously illuminated.

The or each first device may further comprise an on-off push switch, e.g. a tact switch. This may be provided as a power-saving feature, but also as an alternative way of actuating the transmission circuit.

In preferred embodiments the or each of the second devices comprises its own switch for actuating at least its own light.

The set preferably comprises a low number of first devices, e.g. one or two, and a multiplicity of second devices, eg twenty or more. If there are two or more first devices, they may generate differently coded signals, and the second devices may be arranged in groups, the receiver circuits and lights of which respond differently to the differently coded signals.

According to another aspect of the present invention, there is provided an illumination system comprising a set of light-emitting devices of the above type and a desktop or hand-held transmitter unit having at least one switch for causing the generation of a signal to illuminate the light of the or each second device. The signal generated by the transmitter unit is preferably encoded differently from the signal generated by the or each first device, whereby to cause a different illumination effect by the or each second device. In an alternative arrangement the transmitter unit transmits the same code as the or each first device.

The transmitter unit may be connected to a source of music and may have a further switch, actuation of which causes the light of the or each second device to flash in time with the music.

According to another aspect of the present invention, there is provided an illumination system comprising a set of light-emitting devices of the above type and a bottle-supporting unit with at least one bottle placement area and at least one light capable of illuminating a bottle placed on the placement area, the unit having a receiver circuit capable of receiving the transmitted signal and, in response thereto, illuminating its light. The bottle-supporting unit is preferably as described in WO 2012/160930.

The bottle-supporting unit may include its own transmitter circuit which, in response to a bottle being placed on the bottle placement area, causes the generation of a signal which is transmitted to the or each second device to illuminate the light thereof.

The signal generated by the bottle-supporting unit may be encoded differently from the signal generated by the or each first device, whereby to cause a different illumination effect by the or each second device.

The circuitry of the or each second device may be configured to respond completely to a first received signal before responding to a subsequent received signal.

According to another aspect of the present invention, there is provided a method of illuminating containers comprising attaching a set of light-emitting devices to first and second containers, each device comprising a light, associated circuitry and a housing therefor having a surface capable of attachment to the container, wherein at least a first of the set comprises a transmission circuit and means for actuating the transmission circuit to generate a respective transmitted signal, and at least a second of the set comprises a receiver circuit capable of receiving the transmitted signal and means, in response thereto, for illuminating the light of said second device the method comprising using a switch of the first device to actuate the transmission circuit to illuminate the light of the second device.

Preferred embodiments of the present invention will now be described, by way of example only, with reference to the accompanying drawings, of which:

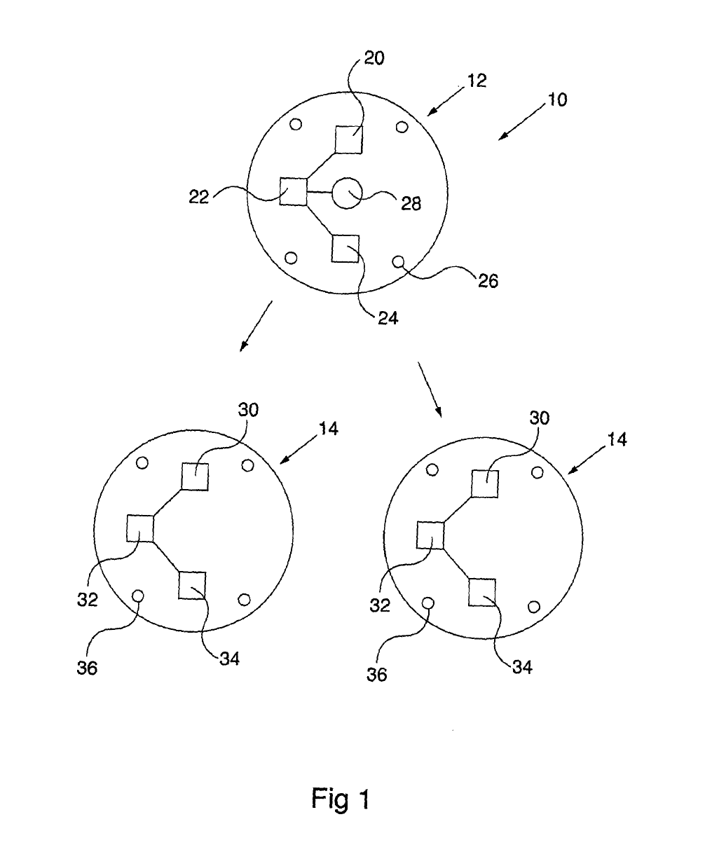

FIG. 1 shows an illumination system in accordance with a first embodiment of the present invention;

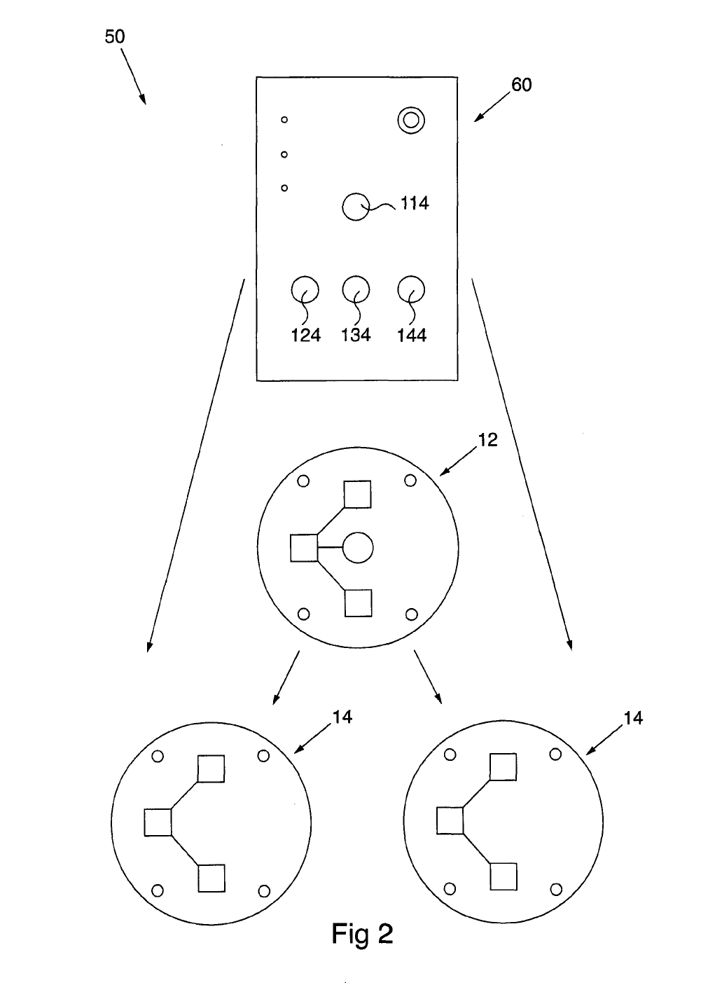

FIG. 2. shows an illumination system in accordance with a second embodiment of the present invention;

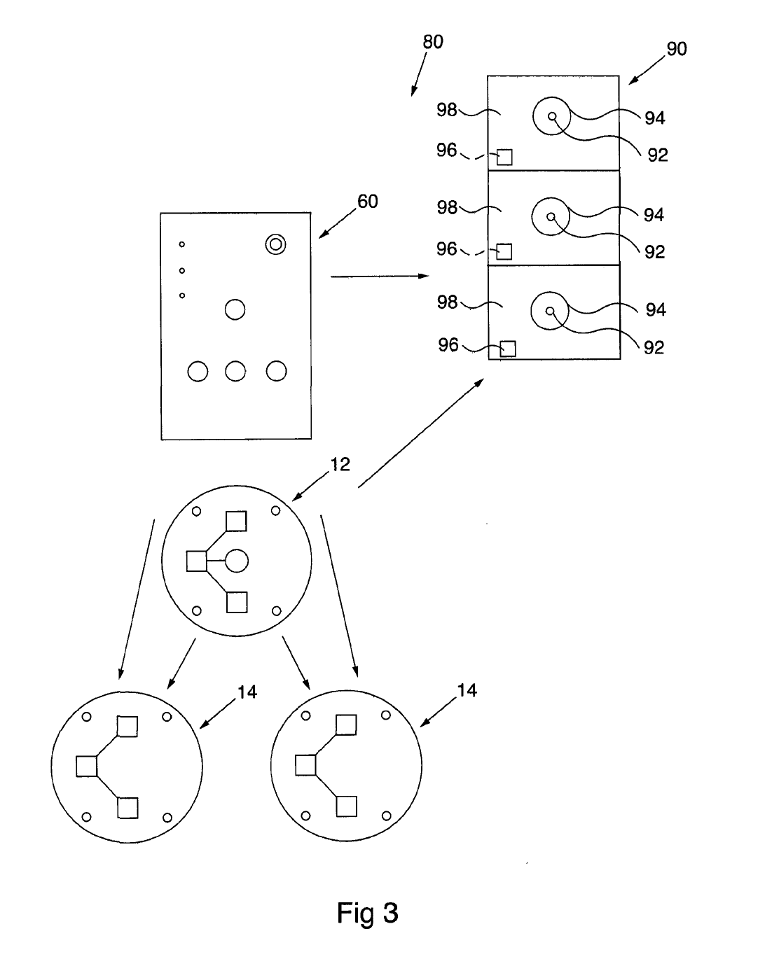

FIG. 3. shows an illumination system in accordance with a third embodiment of the present invention.

Referring now to the drawings, FIG. 1 shows a system 10 comprising a transmitter light device 12 and receiver light devices 14.

The device 12 is of the type disclosed in the above-mentioned patent applications, in particular WO 2011/007113. Thus it comprises a self-contained illumination device for attachment to the exterior of a container, e.g. a bottle, and illuminating the contents thereof. The device comprises a pad with electrical elements of the illumination device attached thereto, the pad being of liquid-impervious material, the electrical elements being provided on a rigid circuit board which is attached to a central region of a major surface of the pad, and the central region being surrounded by an adhesive region of the major surface whereby the pad can be adhered to the container in a liquid-tight manner and the pad is flexible and has a material composition which allows the pad to fold over the edges of the rigid circuit board without cracking or creasing.

In addition, device 12 comprises an on/off switch 28 in the form of a tact switch or other push button switch arranged centrally of the device 12 and actuable from the side opposite the side carrying the other electrical elements.

Furthermore, device 12 comprises a motion-sensitive switch in the form of a tilt switch 20 which, when the device is tilted, activates a transmit circuit 22 to supply an encoded signal to an r.f. transmitter antenna 24.

At the same time as causing the signal to be transmitted, circuit 22 also causes illumination of LEDs 26 of the device 12.

Each device 14 is also of the type disclosed in the above-mentioned patent applications. It further comprises a receiver antenna 34 which supplies r.f. signals received from antenna 24 to a receiver circuit 32 in which the signals are decoded and used to cause illumination of LEDs 36 of the device 14. Each device 14 also includes a tilt switch 30, tilting of which also causes the LEDs 36 of the same device 14 to be illuminated. However, the tilt switches 30 may be omitted from some or all of the devices 14.

In a preferred method of use, the device 12 is attached to the bottom of a dispenser bottle currently in use behind the bar in an entertainment establishment. Devices 14 are attached to the bottom of other bottles in the establishment containing the same type of drink. When a bartender picks up the bottle having device 12 to serve a customer and pours a drink, the tilting of switch 20 causes LEDs 26 and the LEDs 36 of all devices 14 within range to illuminate, for example to flash, while the switch 20 is tilted and for a period of, say, five seconds thereafter. A typical range for the antennas used is 5 to 10 metres.

An advantage of the above-described arrangement is that the advertising effect of the illumination of LEDs 26 is amplified throughout the establishment by simultaneous illumination of the other LEDs 36. By displaying the same effects for the same length of time, an impressive result is observed.

Various modifications can be made to the above-described embodiment. For example illumination of the LEDs 26 of device 12 may be caused directly by switch 28. Alternatively LEDs 26 may be omitted. Lights other than LEDs may be used, for the devices 12 and 14, and each device may have any desired number of lights from one upwards.

Instead of being attached to bottles, the devices 14 can be attached to the bottom of drinks glasses in the possession of customers. A single device 14 only may be provided in the system. Preferably, however, three or more devices 14 are provided, in particular a large plurality such as twenty or more.

In a separate modification, device 12 may be attached to the bottom of a drinks glass instead of a bottle.

In other modifications, more than two devices 12 may be provided. In one example, they are identical and are arranged to be attached to drinks bottles of the same type. In other examples, however, their respective circuitry is arranged to transmit differently encoded signals when tilted. As a simple example, a gin bottle may be arranged to trigger lights flashing at a slow rate, and a vodka bottle may be arranged to trigger lights flashing at a faster rate.

In a further modification, the receiver devices 14 may be arranged in first and second corresponding sets so that a strong illumination effect is triggered in the first set when the gin bottle is tilted and a weak or no illumination effect is triggered when the vodka bottle is tilted, and vice versa.

A third type of illumination effect, e.g. a continuous light signal, may be emitted by LEDs 36 when their own respective device is moved, e.g. tilted.

Instead of being in a master/slave relationship, the devices 12 and 14 may be substantially identical so that they can all transmit and receive signals from each other. In this case transmission circuit 22 is part of transceiver circuitry and receiver 32 is part of transceiver circuitry.

To activate device 12 in use, switch 28 is pressed and this immediately activates circuitry 22 to cause LEDs 26 to illuminate. This gives an indication to the bartender that the device is satisfactorily powered up. At the same time, the LEDs 36 of any receiver devices 14 within range also light up. The circuitry 22 then enters low power standby mode. Thereafter it is woken up from low power standby by activation of tilt switch 20.

To deactivate device 12, switch 28 is pressed again. The LEDs 26, and optionally LEDs 36 of adjacent devices 14, gently fade out to indicate that the device is switching off.

In device 12, the tilt switch 20 or the tact switch 28 may be omitted. If it is the tilt switch which is omitted, the system relies on the bartender to activate switch 28 when pouring, which is not so convenient since this requires a separate positive action.

Devices 14 may also be provided with respective tact switches to switch them on and/or to enable independent illumination even when not tilted. Alternatively, devices 14 may have no switches at all, in which case devices 14 are capable only of remote actuation.

FIG. 2 shows a system 50 in accordance with a second embodiment of the present invention. In addition to the light devices 12 and 14, the system includes a desktop or hand-held transmitter device 60 which can transmit r.f. signals with different codes. Typically this device is in the possession of a disc jockey in an entertainment establishment. It has a typical transmission range of 35 metres.

By actuating one of the push-buttons 124, 134, 144 the disc jockey causes a respective coded signal to be sent to the receiver devices 14, dependent upon which push-button 124, 134 and 144 is actuated. For two of these switches, the effects produced are different from the effect produced by actuation of switch 20 of device 12. For the third of these switches the effect produced may be different from or the same as the effect produced by actuation of switch 20.

The illumination effects can include different flashing rates and different colours but also relatively sophisticated combinations of pre-programmed patterns.

An input of the device 60 is electrically connected to a source of music, such as the disc jockey's mixing desk. If the disk jockey actuates push button 114 on device 60, the light devices 14 can be caused to flash to each bass beat of the music.

The receiver devices 14 of system 50 can thus respond to signals either from transmitter 60 or from device 12. The receiver devices are configured to complete one illumination event before responding to any other transmission. This prevents any illumination event being interrupted.

FIG. 3 shows a system 80 in accordance with a third embodiment of the present invention. In addition to the transmitter device 60, system 80 comprises at least one bottle-supporting unit 90. Details of unit 90 are disclosed in WO 2012/160390. It is a generally planar unit comprising three modules or tiles 98 having respective illumination elements in the form of LEDs 92 on a major surface thereof, electrical circuits for providing electrical power to the illumination elements, the circuits comprising at least one first sensor for sensing the presence of an article over or adjacent to the illumination elements, and a second sensor for sensing the presence or movement of a person adjacent to or in the vicinity of the unit, and externally accessible electrical connection means for connecting the circuits to a similar unit. The unit 90 is typically placed on a shelf or other horizontal support surface and has a plurality of bottle placement areas 94 upon which bottles are placed in use.

The LEDs of the unit upwardly illuminate bottles in placement areas 94. The unit 90 incorporates an r.f. receiver 96 for receiving coded signals from the light device 12 and the transmitter device 60, so that LEDs 92 can display the same illumination effects. Internal circuitry of the unit 90 decides which LEDs to illuminate, e.g. in dependence upon which of the areas 94 is/are currently occupied by a bottle. This function is also disclosed in WO 2012/160390.

In a modification, each module 98 incorporates a respective receiver 96, as shown in broken lines in FIG. 3.

In a modification, unit 90 includes one or more transmitters so that when a passive infra-red sensor of the unit is actuated by sensing the presence or approach of a person, or when a vibration sensor thereof is actuated, a coded transmission signal is sent out to cause devices 14 to light up too.

The features and modifications of the embodiments may be combined or interchanged as desired. For example, the transmitter device 60 can be omitted from the embodiment of FIG. 3, so that the system comprises only the light devices 12 and 14, and the modular light panel unit 90.

1.-15. (canceled)

16. A set (12, 14) of light-emitting devices, each capable of being attached to a respective container and each comprising a light (26, 36), associated circuitry and a housing therefor having a surface capable of attachment to the container, wherein at least a first (12) of the set comprises a transmission circuit (22) and a user-actuated switch (20; 28) for actuating the transmission circuit to generate a respective transmitted signal, and at least a second (14) of the set comprises a receiver circuit (32) capable of receiving the transmitted signal and means, in response thereto, for illuminating the light (36) of said second device.

17. The set according to claim 16, wherein each device (12, 14) comprises a pad of liquid-impervious material and with electrical elements of the device attached to a central region of a major surface thereof, the central region being surrounded by an adhesive region of the major surface whereby the pad can be adhered to a container in liquid-tight manner to illuminate the contents thereof.

18. The set according to claim 17, wherein the pad has a thickness in the range of 0.15 to 0.40 mm and/or a maximum dimension of 30 to 70 mm.

19. The set according to claim 16, wherein each device (12, 14) comprises a pad with electrical elements of the light-emitting device attached thereto, the pad being of liquid-impervious material, the electrical elements being provided on a rigid circuit board which is attached to a central region of a major surface of the pad, and the central region being surrounded by an adhesive region of the major surface whereby the pad can be adhered to the container in a liquid-tight manner to illuminate the contents thereof and the pad is flexible and has a material composition which allows the pad to fold over the edges of the rigid circuit board without cracking or creasing.

20. The set according to claim 19, wherein the pad has a thickness in the range of 0.15 to 0.40 mm and/or a maximum dimension of 30 to 70 mm.

21. The set according to claim 16, wherein the switch (20) is a motion-sensitive switch.

22. The set according to claim 21, wherein each first device further comprises an on-off push switch (28).

23. The set according to claim 16, wherein the switch (28) is an on-off push switch.

24. The set according to claim 16, comprising a single first device (12) and a plurality of second devices (14).

25. The set according to claim 16, comprising at least two first devices (12), one of which transmits a signal with a first code and the other of which transmits a signal with a second code, the second devices (14) being arranged in two groups, the members of one of which groups respond to signals having the first code and members of the other of which groups respond to the signals having the second code.

26. The set according to claim 25, wherein the second devices (14) generate different illumination effects in response to the different coded signals.

27. The set according to claim 16, wherein each first device (12) comprises means for illuminating the light (26) of said first device simultaneously with the generation of the transmitted signal.

28. The set according to claim 16, wherein each of the second devices comprises its own switch (30) for actuating at least its own light (36).

29. An illumination system comprising a set of light-emitting devices (12, 14) in accordance with any preceding claim and a desktop or hand-held transmitter unit (60) having at least one switch (114, 124, 134, 144) for causing the generation of a signal to illuminate the light of the or each second device (14).

30. A method of illuminating containers comprising attaching a set of light-emitting devices (12, 14) to first and second containers, each device comprising a light (26, 36), associated circuitry and a housing therefor having a surface capable of attachment to the container, wherein at least a first (12) of the set comprises a transmission circuit and means for actuating the transmission circuit to generate a respective transmitted signal, and at least a second (14) of the set comprises a receiver circuit capable of receiving the transmitted signal and means, in response thereto, for illuminating the light (36) of said second device the method comprising using a switch (20, 28) of the first device to actuate the transmission circuit to illuminate the light of the second device.

31. The method according to claim 30, wherein the containers are drinks containers and the illumination of at least the second devices (14) is arranged to illuminate the contents of the containers to which they are attached.
